(19) United States
(12) Patent Application Publication
(10) Pub. No.: US 2003/0143993 A1
(43) Pub. Date: Jul. 31, 2003

(54) Remote operation system, and an electronic apparatus to be controlled by a remote operation apparatus

(76) Inventor: Hiroaki Nagaoka, Saitama (JP)

Correspondence Address: COOPER & DUNHAM LLP, 1185 Avenue of the Americas, New York, NY, 10036, US

(21) Appl. No.: 10/336,349

(22) Filed: Jan. 3, 2003

(30) Foreign Application Priority Data
Jan. 7, 2002 (JP) P2002-000825

(51) Int. Cl. H04M 3/00

(52) U.S. Cl. 455/420; 455/70

(57) ABSTRACT

In a timer recording system, contents for a timer recording processing for requested TV program is transmitted to a timer recording management server by a mobile phone, then the timer recording management server commands to a video tape recorder to execute the timer recording operation. The video tape recorder executes such timer recording processing, and when the timer recording processing ends, the video tape recorder reports the processing result to the mobile phone, thereby the user is able to confirm the setting of the timer recording to the video tape recorder that is not directly operated by the user. The present invention may be used for an electronic apparatus such as a tape recorder, a VTR, or an air conditioner. When the user is not able to directly operate the electronic apparatus at home while the user is go out from home, the user is able to control and to confirm the operation of the electronic apparatus.

### CROSS REFERENCE TO RELATED APPLICATIONS

This application claims priority from Japanese Priority Document No. P2002-000825, filed on Jan. 7, 2002 with the Japanese Patent Office, which document is hereby incorporated by reference.

### BACKGROUND OF THE INVENTION

1. Field of the Invention

This invention relates to a remote operation system, and an electronic apparatus to be controlled by such remote operation controller, and is particularly suitable for remotely controlling an electronic apparatus through a mobile phone.

2. Related Art

Conventionally in a video tape recorder, for example, a TV program requested by a user is able to be automatically recorded based on a timer recording data preset to the video tape recorder by the user in advance. In such video tape recorder, there is a problem, that is, when a user is not able to directly operate an operating section of the video tape recorder because the user is out of home, for example, it is impossible to preset the timer recording data for the requested TV program to the video tape recorder.

### SUMMARY OF THE INVENTION

The present invention was carried out in consideration of the above problems, and proposes a remote operation system capable of operating an electronic apparatus placed within an environment where a user is not able to directly operate the electronic apparatus, an electronic apparatus to be controlled remotely, a method for reporting a processing status in case of remotely controlling an electronic apparatus, a program for the method for reporting a processing status of such remote control operation, and a recording medium to which such program for the method for reporting the processing status is stored.

In order to solve the above-mentioned problems according to the present invention, in a remote operation system including an operation terminal, a remote operation management apparatus, and an electronic apparatus to be controlled, wherein the operation terminal presets processing contents of a predetermined processing to be executed by the electronic apparatus, the remote operation management apparatus commands to the electronic apparatus to execute the predetermined processing based on the processing contents preset by the operation terminal, the electronic apparatus executes the predetermined processing based on the processing contents in response to the command, and in addition, recognizes a processing status of the predetermined processing by the electronic apparatus, and reports the recognized result to the operation terminal. Accordingly, a user is able to have the electronic apparatus, which the user is not able to directly operate, execute the predetermined processing based on the processing contents preset through the operation terminal, and is able to confirm the processing status of the executed predetermined processing.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic diagram showing a total configuration of a timer recording system as one embodiment of a remote operation system of the present invention;

FIG. 2 is a block diagram showing a circuit configuration of a mobile phone;

FIG. 3 is a block diagram showing a circuit configuration of a timer recording management server;

FIG. 4 is a block diagram showing a circuit configuration of a video tape recorder;

FIG. 5 is a flowchart showing a remote operating timer recording processing sequences;

FIG. 6 is a schematic diagram showing a total configuration of a timer recording TV program table display image;

FIG. 7 is a schematic diagram showing a total configuration of a timer recording setting contents confirmation display image;

FIG. 8 is a schematic diagram showing a total configuration of a timer recording processing result reporting display image;

FIG. 9 is a schematic diagram showing a total configuration of the record processing end report display image; and

FIG. 10 is a schematic diagram showing a total configuration of the record processing start report display image.

### DETAILED DESCRIPTION OF THE PREFERRED EMBODIMENTS

Here in after, one embodiment of the present invention is described in detail with reference to accompanying drawings.

1. A Total Configuration of a Timer Recording System:

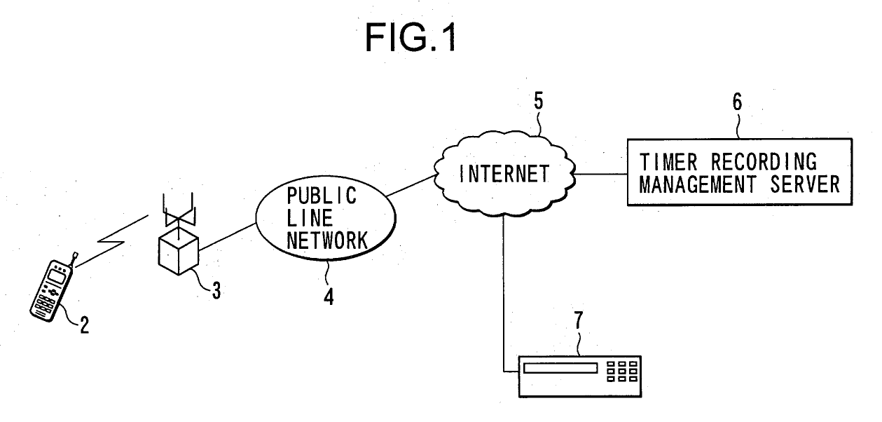

In FIG. 1, a reference numeral 1 designates a timer recording system as a remote operation system to which the present invention is adapted as a whole, wherein a mobile phone 2 is connected to a base station 3 through a radio wave, and is connected to a public line network 4 by way of the base station 3. Further the mobile phone 2 is so arranged as to have various data communications with a timer recording management server 6 connected to the internet 5 through the public line network 4.

The timer recording management server 6 restores a timer recording TV program table classified by each on-air date and each on-air channel as a web page, and when the web page of the timer recording TV program table having particularly specified the on-air date and the on-air channel is requested from the mobile phone 2 connected to the internet 5, then timer recording management server 6 offers the web page to the mobile phone 2 that issues the request.

The video tape recorder 7 is always connected to the internet 5 by way of an internet connection provider such as called as an ISP (Internet Service Provider), although not shown here, and is arranged to be able to perform various data communications with the timer recording management server 6 through the internet 5. In this case in the video tape recorder 7, the video tape recorder 7 is arranged to be specified in the internet 5 by allocating an unique IP (Internet Protocol) address.

In addition, the video tape recorder 7 is arranged to receive a television broadcast signal comprised of a video signal and an audio signal via an outdoor antenna and the like, although not shown here, and if a timer recording for the user requested TV (Television) program is preset to the video tape recorder 7 by carrying out a predetermined operation, then a predetermined recording processing is automatically executed at the on-air start time of the television program, and the television broadcast signal of the TV program is to be magnetically recorded to a video cassette tape, although not shown, installed into the video tape recorder 7.

1-1. A Circuit Configuration of a Mobile Phone:

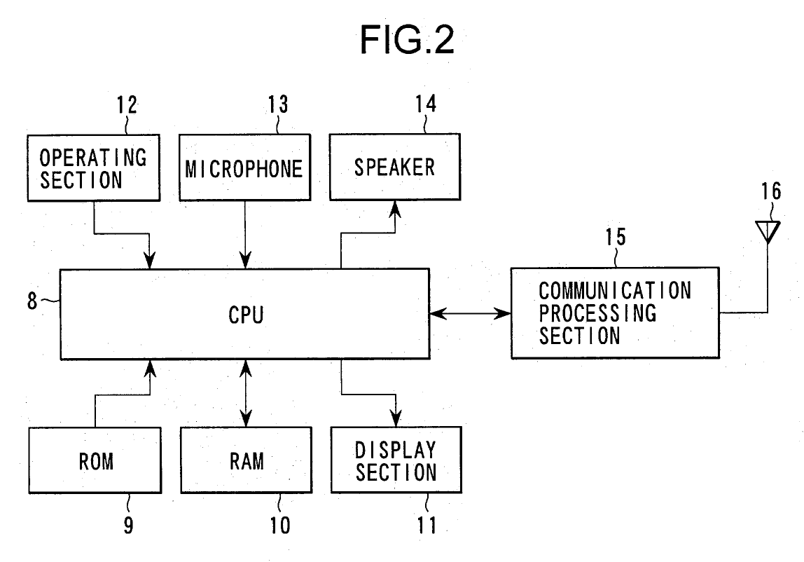

Next, a circuit configuration of the mobile phone 2 to be used in the present invention is explained with reference to FIG. 2.

The mobile phone 2 is so configured that a ROM (Read Only Memory) which stores various programs such as a basic program, a web browser program, an e-mail program and the like, a RAM (Random Access Memory) to serve as a work area, a display section 11 comprised of a liquid crystal display and the like, an operating section 12 comprised of a plural kinds of operation keys, a microphone 13, a speaker 14, and a communication processing section 15 are respectively connected to a CPU (Central Processing Unit) 8 which totally controls all of the mobile phone 2.

The CPU 8 of the mobile phone 2 executes various processing by duly spreading various programs such as a basic program, a web browser program, and an e-mail program stored in the ROM 9 to the RAM 10, and displays the processing result thereof at the display section 11.

For example, in accordance with the basic program, the CPU 8 of the mobile phone 2 executes various communication processing such as an outgoing call processing and a call termination processing by controlling a communication processing section 15 in response to a operation command entered through an operating section 12.

In addition, the CPU 8 of the mobile phone 2 also controls the communication processing section 15 and executes various data communication with the timer recording management server 6 connected to the internet 5 by transmitting/receiving communication data via an antenna element 16.

The CPU 8 of the mobile phone 2 regularly checks a mail box which stores e-mails addressed to the mobile phone 2 provided in a mail-server (not shown) connected to the internet 5 in accordance with the e-mail program, and if an e-mail is in the mail box, then takes it to store in the RAM 10 of the mobile phone 2 as a received mail.

When a predetermined received mail display operation is carried out by operating the operating section 12, then the CPU 8 of the mobile phone 2 reads out the received mail from the RAM 10 corresponding to the received mail display operation, and displays the contents of the read out received mail on the display section 11.

Further, when a predetermined operation for displaying the timer recording TV program table of the specified on-air day and the on-air channel is carried out by operating the operating section 12, the CPU 8 of the mobile phone 2 requests the web page of the timer recording TV program table to the timer recording management server 6 in accordance with the web browser program, and is to display the web page at the display section 11 after taking in the web page of the timer recording TV program table transmitted from the timer recording management server 6 in response to the request.

1-2. A Circuit Configuration of the Timer Recording Management Server:

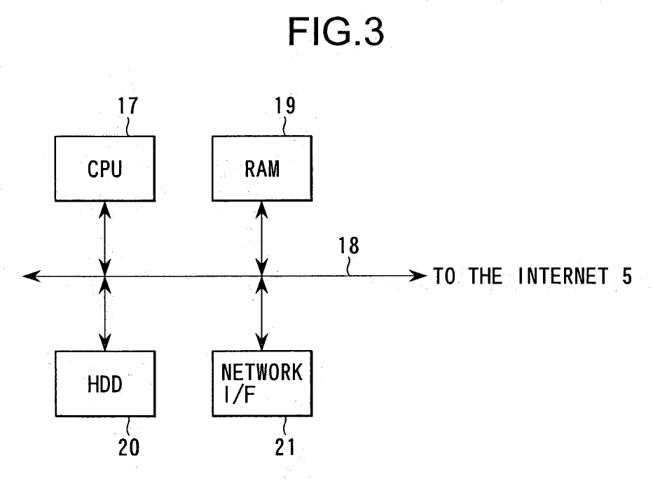

Now, a circuit configuration of the timer recording management server 6 as a remote operation management apparatus according to the present invention is explained with reference to FIG. 3.

In the timer recording management server 6, a CPU 17 for totally controlling all of the timer recording management server 6 is so configured to be connected with to a RAM 19, a hard disk drive 20, and a network interface 21 via a bus 18.

The hard disk drive 20 stores various programs such as a basic program, a WWW (World Wide Web) server program, a timer recording command program (later described) commanding execution of the timer recording processing to the video tape recorder 7, and the like

Accordingly, the CPU 17 of the timer recording management server 6 duly reads out these programs timely from the hard disk drive 20, executes them while spreading in the RAM 19, and thereby executes various processing while controlling respective circuit section of the timer recording management server 6.

In addition, the hard disk drive 20 stores video tape recorder address information, and further stores the timer recording TV program table classified by the on-air date and the on-air cannel as web pages having image information formed with a JPEG (Joint Photographic Experts Group) format and the like and with text information of a HTML (Hyper Text Markup Language) format and the like.

When the web page of the specified on-air date and the on-air channel in the timer recording TV program table is requested via the mobile phone 2, for example, the CPU 17 of the timer recording sever 6 reads out the web page corresponding to the request among web page groups of the timer recording TV program table stored and classified in the hard disk by the on-air date and the on-air channel, and is so arranged to transmit the web page to the requesting mobile phone 2 through the network interface 21, and through the internet 5 in sequence.

1-3. A Circuit Configuration of the Video Tape Recorder:

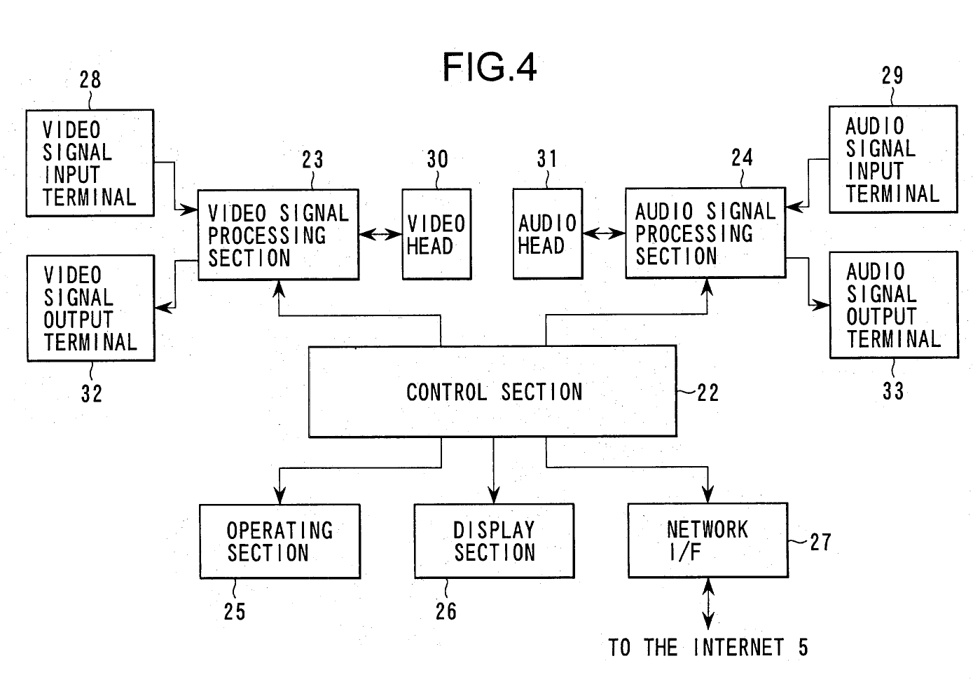

Then a circuit configuration of the video tape recorder 7 to be used in the present invention is described with reference to FIG. 4.

The video tape recorder 7 is so configured that a video signal processing section 23, an audio signal processing section 24, an operating section 25, a display section 26 and a network interface 27 are connected to a control section 22 which controls the total operation of the video tape recorder 7 comprised of a CPU, a ROM, a RAM, a RTC (Real Time Clock), and the like (although they are not shown).

The control section 22 duly reads out various programs such as a recording/reproducing program, a timer recording program, a processing status reporting program, an operating system program, and the like stored in the ROM upon request, expands in the RAM to execute various processing by controlling respective circuit section of the video tape recorder 7, and displays the processing result at the display section 26.

A video signal input terminal 28 and an audio signal input terminal 29 are, for example, connected to an antenna (not shown). Accordingly, when a television broadcast signal including the video signal and the audio signal is received by the antenna, the video tape recorder 7 is so configured as to take in the video signal and the audio signal of thus received television broadcast signal into the video tape recorder 7 through the video signal input terminal 28 and the audio signal input terminal 30, respectively.

When a predetermined recording operation is carried out by operating the operating section 25, the control section 22 executes magnetic recording for the television broadcast signal of the TV program depending on the recording operation to the video cassette tape (not shown) installed in the video tape recorder 7 by controlling the video signal processing section 23 and the audio signal processing section 24 in accordance with the recording/reproducing program.

Namely, when recording the TV program, the video signal processing section 23 executes a predetermined compression coding processing to the taken video signal through the video signal input terminal 28 under the control of the control section 22, and magnetically records thus generated recording video signal to the video cassette tape by a video head 30. In addition, the audio signal processing section 24 simultaneously executes a predetermined compression coding processing to the taken audio signal through the audio signal input terminal 29 under the control of the control section 22, and magnetically records thus generated recording audio signal to the video cassette tape by an audio head 31.

Further, when reproducing the TV program recorded in the video cassette tape, the control section 22 reads out the video signal and the audio signal magnetically recorded in the video cassette tape by controlling the video signal processing section 23 and the audio signal processing section 24 in accordance with the recording/reproducing program, and then outputs to a peripheral device such as a television monitor (not shown) connected to the video tape recorder 7.

Namely, the video signal processing section 23 executes a predetermined expansion decoding processing to the reproduced recorded video signal read out from the video cassette tape by the video head 30 in response to the control by the control section 22 upon reproducing the TV program, and then outputs thus. obtained video signal through the video signal output terminal 32 to the external device such as television monitor, or the like connected to the video signal output terminal 32. Further, simultaneously, the audio signal processing section 24 executes a predetermined expansion decoding processing to the reproduced recorded audio signal from the video cassette tape through the audio head 31 in response to the control by the control section 22, and outputs thus obtained audio signal through the audio signal output terminal 32 to the external device such as television monitor, or the like connected to the audio signal output terminal 32.

Further when a G-code (Trademark), for example, is entered to the control section 22 by operating the operating section 25, the control section 22 is so constructed to automatically preset the timer recording of the TV program corresponding to the G-code in accordance with the timer recording program.

Here, the G-code means a code expressed by 8 digits in maximum by encrypting after compression coding the input information (this is called as a timer recording input information) such as the on-air date, the on-air channel, the start time, the length and the like for the TV program which are necessary for presetting the timer recording. In the video tape recorder 7, it is able to easily preset the timer recording by using the G-code without entering the respective timer recording input information.

When the current time clocked in the RTC circuit provided inside of the control section 22 becomes the on-air time on the on-air date for the TV program to be recorded under the condition where the timer recording is preset, the control section 22 automatically starts the recording processing for the TV program in accordance with the above mentioned recording/reproducing program.

Further, when the predetermined user ID and the corresponding password from the mobile phone 2 via the timer recording management server 6 are received, the control section 22 executes the user authentication by verifying the received user ID and the corresponding password with each of a plurality of user IDs and corresponding passwords recorded as the user authentication information in accordance with the operating system program. Herein, the user authentication information is the information describing the user ID and the corresponding password of the user who is authorized to operate the video tape recorder 7, and previously stored in the RAM provided inside of the control section 22.

When the user ID and the corresponding password received from the mobile phone 2 via the timer recording management server 6 are recorded among the user authentication information previously stored in the RAM, then the control section 22 determines that the user of the mobile phone 2 is an authorized user for operating the video tape recorder 7, and then gives an authorization as to be able to control various processing such as a timer recording and the like to the timer recording management server 6 that operates based on the command information supplied from the mobile phone 2.

The control section 22 recognizes a processing status of the timer recording processing and the recording processing in accordance with the processing status reporting program, generates an e-mail describing the contents of the processing status thus recognized, and transmits to the mobile phone 2 as a processing status reporting mail. In this case, the e-mail address of the mobile phone 2 as an reporting opponent is previously stored in the RAM internally provided in the control section 22 as the information for the processing status reporting opponent.

2. A Preset of the Timer Recording According to the Present Invention:

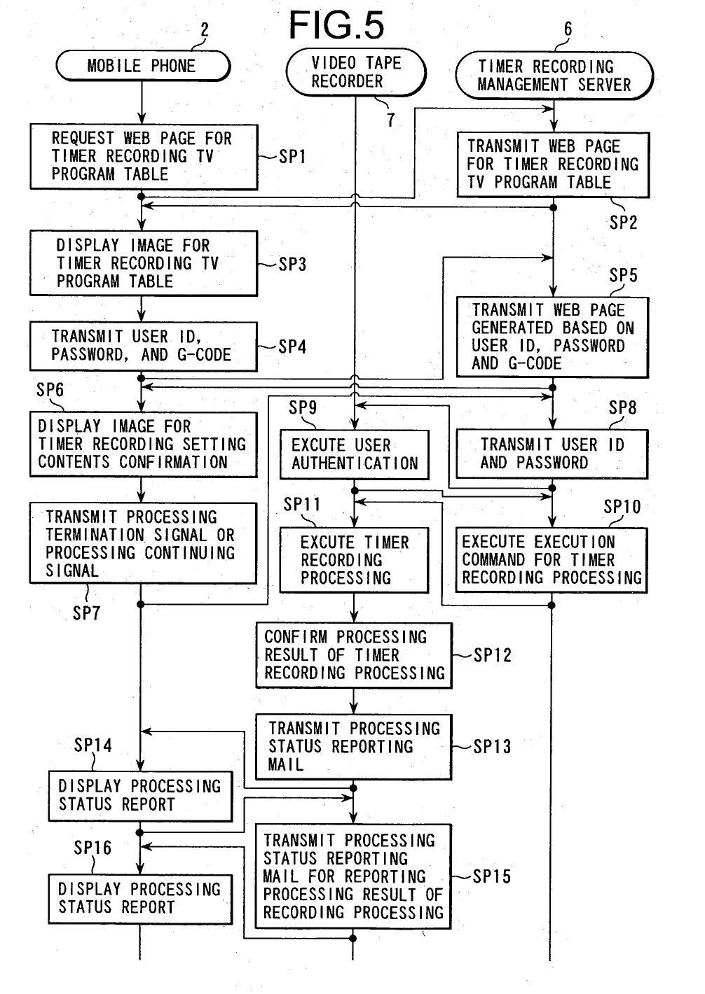

Next, in the timer recording system 1 of the present invention, and in case of presetting the timer recording for the TV program requested by a user to the video tape recorder 7, an execution procedure of various processing executed by the mobile phone 2, the timer recording management server 6, and the video tape recorder 7 is explained in accordance with a remote operating timer recording processing sequence as shown in FIG. 5.

At step SP1, when the operation for displaying the timer recording television program table of the on-air date and the on-air channel requested by a user at the display section 11 through the operating section 12 is carried out, the CPU 8 of the mobile phone 2 requests to transmit the web page of the related timer recording TV program table to the timer recording management server 6, and proceeds the processing to step SP2.

At step SP2, when receiving a request for transmitting the web page of the timer recording TV program table of the specified on-air date and the on-air channel, the CPU 17 of the timer recording management server 6 reads out the requested web page from the hard disk drive 20, transmits this web page to the mobile phone 2 as a requester, and proceeds the processing to next step SP3.

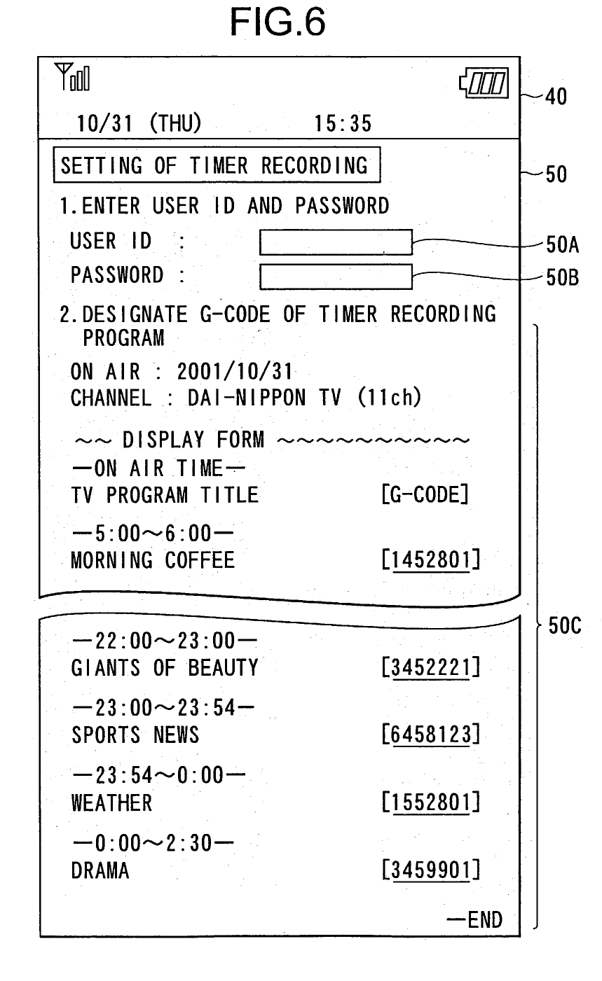

At step SP3, when receiving the web page transmitted from the timer recording management server 6, the CPU 8 of the mobile phone 2 displays, based on this, a timer recording TV program table display image 50 at the display section 11 as shown in FIG. 6, and proceeds the processing to next step SP4.

Practically, on the display section 11 of the mobile phone 2, a timer recording TV program table display image 50 and a standard information display image 40 designating various information such as a receiving condition of a radio wave, a residual battery power level, a current time and date, and the like are displayed. A user ID input box 50A and a password input box 50B are displayed in the timer recording TV program table display image 50, and further a list of TV programs to be broadcasted on the on-air date and the on-air channel requested by the user is displayed in a TV program list table display area 50C.

Further in the TV program list table display area 50C of the timer recording TV program table display image 50, a plurality of TV programs to be broadcasted at the on-air date Oct. 31, 2001 and the on-air channel [Dai-nippon TV (channel 11)], for example, are displayed as a list, and further the G-code corresponding to respective TV program is displayed in selectable form with an anchor.

At step SP4, when the previously assigned user ID [hanako] and the corresponding password are entered in the user ID input box 50A and password input box 50B, respectively, of the timer recording TV program table display image 50 using the operating section 12, and then a G-code for the recording TV program requested by the user, for example, the G-code [6458123] for the title “Sports News” of the TV program in the TV program list display area 50C, for example, is entered, then the CPU 8 of the mobile phone 2 transmits the user ID, the password and the G-code to the timer recording management server 6, and proceeds the processing to next step SP5.

In this case, the user ID and the password may be previously stored in the RAM 10 of the mobile phone 2. In such case, when the CPU 8 of the mobile phone 2 displays the timer recording TV program table display image 50, the CPU 8 reads out the user ID and the password stored in the RAM 10 and automatically enters them in the user ID input box 50A and the password input box 50B, respectively, then the input operation by the user is able to be simple.

At step SP5, after the CPU 17 of the timer recording server 6 stores the user ID, the password, and the G-code received from the mobile phone 2 into the hard disk drive 20, the CPU 17 generates a web page based on these data, transmits the generated web page to the mobile phone 2, and proceeds the processing to next step SP6.

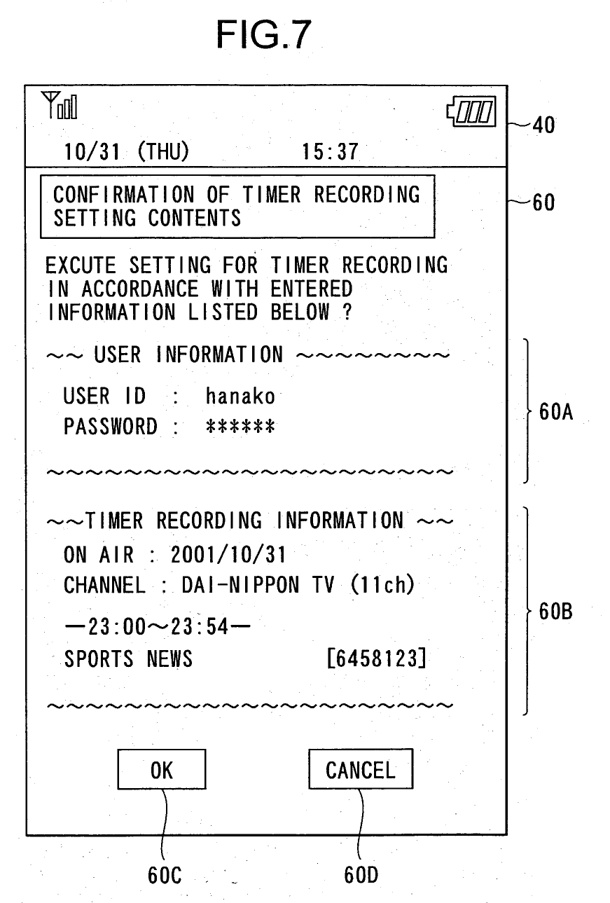

At step SP6, when receiving the web page transmitted from the timer recording management server 6, the CPU 8 of the mobile phone 2 displays a timer recording preset contents confirmation display image 60 on the display section 11 based on the web page as shown in FIG. 7, has the user recognize on the display section 11 the timer recording information for the TV program corresponding to the user ID entered and the G-code selected by the user, and then proceeds the processing to next step SP7.

In this case, in the timer recording preset contents confirmation display image 60, the user ID [hanako] is displayed in the user information display area 60A, and in addition, the corresponding password is also displayed in a concealed form, and further, the timer recording information for the TV program corresponding to the G-code selected by the user is displayed in the timer recording program information display area 60B, and in addition, an OK button 60C and a CANCEL button 60D are displayed on the bottom section of the timer recording program information display area 60B.

At step SP7, when the CPU 8 of the mobile phone 2 recognizes that the OK button 60C is clicked by judging that the user ID displayed on the timer recording preset contents confirmation display image 60 is judged as correct one by the user, and further the timer recording information for the TV program displayed there is judged as the correct timer recording information for the TV program requested by the user, then the CPU 8 transmits the processing continuing signal to the timer recording management server 6, and proceeds the processing to next step SP8.

In this case, when the CPU 8 of the mobile phone 2 recognizes that the CANCEL button 60D is clicked by judging that the user ID displayed on the timer recording preset contents confirmation display image 60 is judged as improper one by the user, or the timer recording information for the TV program displayed there is judged as an incorrect timer recording information for the TV program requested by the user, then the CPU 8 transmits the processing discontinuing signal to the timer recording management server 6. When receiving the processing discontinuing signal from the mobile phone 2, the CPU 17 of the timer recording management server 6 erases the user ID, the password, and the G-code stored in the hard dick drive 20, and does not execute further processing.

At step SP8, when receiving the process continuing signal from the mobile phone 2, the CPU 17 of the timer recording management server 6 searches the video tape recorder address information based on the received user ID at step SP5 in accordance with the timer recording command program, and finds out the IP address of the video tape recorder owned by the user. In this case, the video tape recorder address information is the information which describes the user ID of the user who utilizes the timer recording system 1 and the IP address of the video tape recorder owned by the user corresponding to each other, and is stored in the hard disk drive 20 in advance.

After specifying the video tape recorder 7 on the internet 5 based on the searched IP address, the CPU 17 of the timer recording management server 6 transmits the received user ID and the password from the mobile phone 2 to the specified video tape recorder 7, and proceeds the processing to next step SP9.

At step SP9, the control section 22 of the video tape recorder 7 executes the user authentication by verifying the user ID and the password received from the mobile phone 2 via the timer recording management server 6 with the user ID and the corresponding password recorded as the user verification information. In this case, if the received user ID and the password are recorded as the user verification information, the control section 22 judges that the user of the mobile phone 2 is the proper user who is authorized to operate the video tape recorder 7, gives an appropriate authority to be able to command for executing various processing such as the timer recording processing, or the like to the timer recording management server 6 that operates based on the command information given from the mobile phone 2, and proceeds the processing to next step SP10.

In this case, if the user ID and the password received from the mobile phone 2 via the timer recording management server 6 are not recorded as the user authentication information, the CPU 17 of the timer recording management server 6 reports to the mobile phone 2 that the user ID and the corresponding password entered by the user are not appropriate, and quits to execute the processing thereafter.

Thus, the video tape recorder 7 executes the user authentication based on the user ID and the password, and it is able to protect the video tape recorder 7 from being illegally operated by the accessible third party via the internet 5.

At step SP10, the CPU 17 of the timer recording management sever 6 transmits the execution command of the timer recording processing for performing the timer recording of the TV program corresponding to the G-code received from the mobile phone 2 in accordance with the timer recording command program, and proceeds the processing to step SP11.

At step SP11, when the control section 22 of the video tape recorder 7 receives the execution command from the timer recording management server 6, then executes the timer recording processing in accordance with the execution command, and proceeds the processing to next step SP12.

At step SP12, when the control section 22 of the video tape recorder 7 finishes the timer recording processing, the control section 22 recognizes the processing result of the timer recording processing, and proceeds the processing to next step SP13.

At step SP13, the control section 22 of the video tape recorder 7 generates a processing status reporting mail based on the processing result of the recognized timer recording processing, transmits thus generated processing status reporting mail to the mobile phone 2, and proceeds the processing to step SP14.

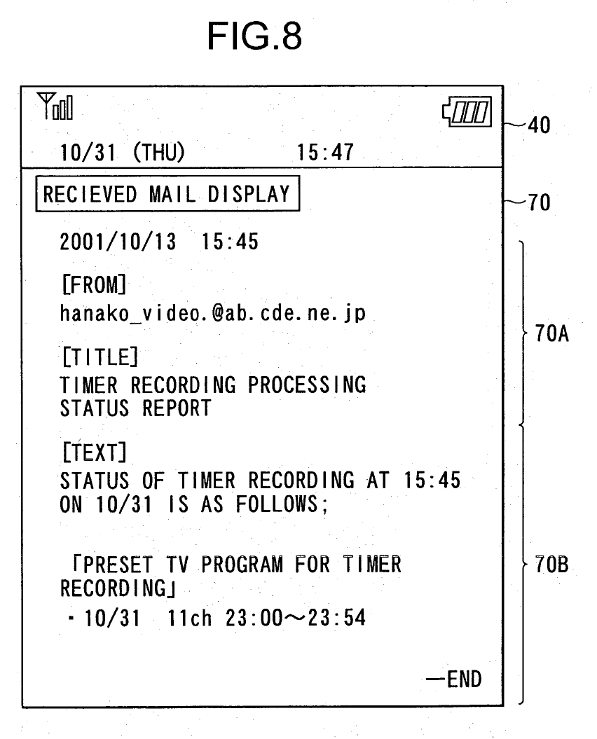

At step SP14, after receiving the processing status reporting mail transmitted from the video tape recorder 7, the CPU 8 of the mobile phone 2 displays on the display section 11 a timer recording processing result reporting display image 70 as shown in FIG. 8 based on the received processing status reporting mail when the user carries out a predetermined received mail display operation.

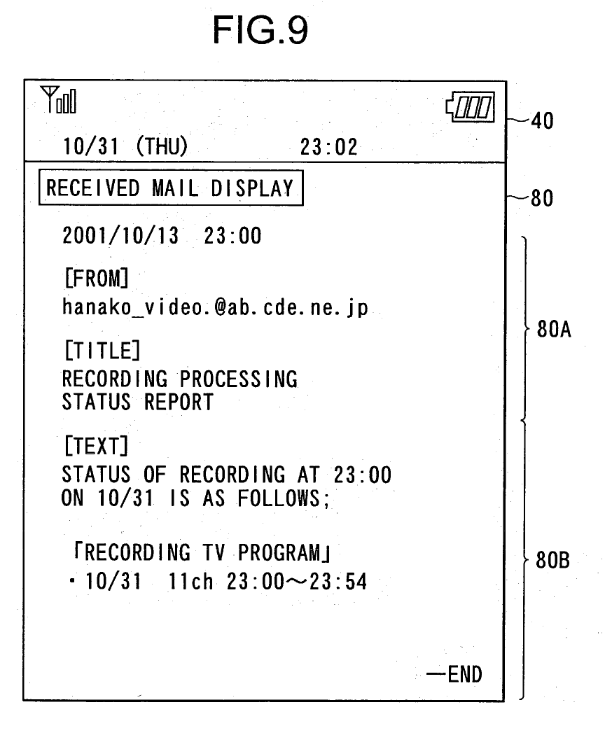

In this case, the transmission date of the e-mail, the e-mail address of the sender, the title, and the like are displayed at a header area 70A in the timer recording processing result reporting display image 70, while the timer recording processing and the contents of the processing status for the recording processing are displayed at a text display area 70B. Further, a header area 80A and a header area 90A in a recording processing start reporting display image 80 in FIG. 9 and a recording processing end reporting display image 90 have the same configuration as the above described header area 70A, and a respective text display area 80B and a text display area 90B have the same configuration as the above described text display area 70B, and accordingly the explanation thereof is omitted here.

Accordingly, the user is able to confirm the presetting of the timer recording for the requested TV program to the video tape recorder 7 that the user is not able to operate directly, by watching the contents of “The timer recording registered TV program” displayed at the text display area 70B of the timer recording processing result reporting display image 70 in FIG. 8, namely such as the on-air date as “October 31”, the on-air channel as “Channel 11”, and the on-air time as “23:00 to 23:54” corresponding to the G-code for the TV program selected by the user.

At step SP15, the control section 22 of the video tape recorder 7 is so configured as to recognize the processing status of the recording processing at the time when the recording processing starts and at the time when the recording processing ends, and when the control section 22 recognizes the processing status for the recording processing at respective time, the control section 22 generates the processing status reporting mail based on the recognized result, transmits this mail to the mobile phone 2, and proceeds the processing to next step SP16.

At step SP16, when receiving the processing status reporting mail generated at the time when the recording processing for the TV program starts, and when a predetermined received mail display operation is carried out by the user, the CPU 8 of the mobile phone 2 displays the timer recording processing start reporting display image 80 at the display section 11 as shown in FIG. 9 based on the received timer recording processing status reporting mail. Accordingly, the user is able to confirm the start of the recording for the requested TV program by watching the contents of “The recording TV program” displayed at the text display area 80B of the recording processing start reporting display image 80 in FIG. 9, namely such as the on-air date as “October 31”, the on-air channel as “Channel 11”, and the on-air time as “23:00 to 23:54” corresponding to the user selected G-code for the TV program.

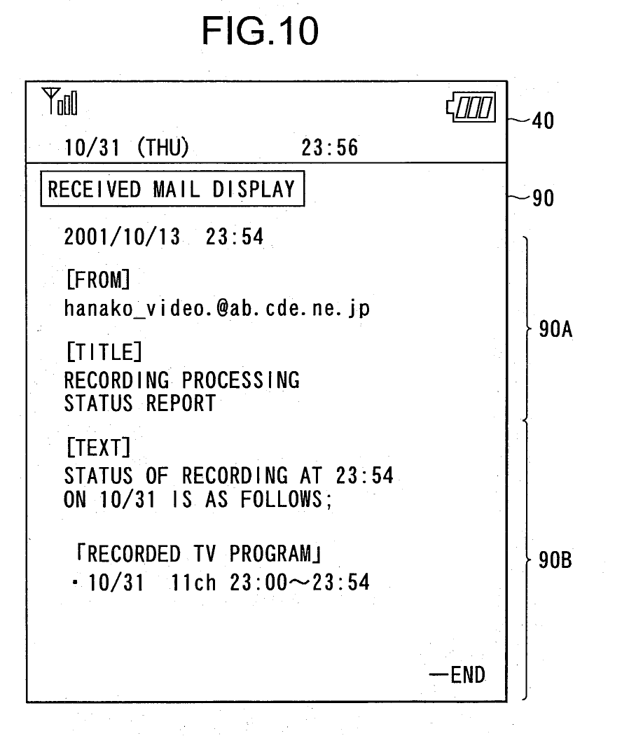

Further, when receiving the processing status reporting mail generated at the time when the recording processing for the TV program ends is received, and when a predetermined received mail display operation is carried out by the user, the CPU 8 of the mobile phone 2 displays the timer recording processing start reporting mail as shown in FIG. 9 based on the received timer recording processing status reporting mail at the display section 11. Accordingly, the user is able to confirm the end of the recording for the TV program by watching the contents of “The recording TV program” displaying at the text display area 90B of the recording processing end reporting display image 90 in FIG. 10, namely such as the on-air date as “October 31”, the on-air channel as “Channel 11”, and the on-air time as “23:00 to 23:54” corresponding to the user selected G-code for the TV program.

Thus, the timer recording system 1 is able to provide a relief to the user by watching the contents of “The timer recording registered TV program” displayed at the text display area 70B of the timer recording processing result reporting display image 70 in FIG. 8, and by confirming the presetting of the timer recording for the requested TV program to the video tape recorder 7 that is not directly operated by the user, and in addition, the timer recording system 1 is able to have the user recognize that the user requested TV program was recorded by watching the contents of “The recording TV program” and “The recorded TV program” displayed at the text display area 80B of the recording processing start reporting display image 80 in FIG. 9 and at the text display area 90B of the recording processing end reporting display image 90 in FIG. 10.

3. Operation and Advantage

In the above mentioned configuration, when the user ID, the corresponding password, and the timer recording input information (G-code) for the TV program requested by the user are entered at the timer recording TV program table display image 50 in FIG. 6, the CPU 8 of the mobile phone 2 presets the processing contents for the timer recording processing to be executed by the video tape recorder 7 by transmitting thus entered user ID, the password, and the timer recording information to the timer recording management server 6.

Then, the CPU 17 of the timer recording management server 6 transmits the received user ID and password to the video tape recorder 7, and when the user authentication based on the user ID and password is executed by the video tape recorder 7 and a proper authorization for controlling various processing such as the timer recording processing, and the like is given, then the timer recording management server 6 transmits the execution command for the timer recording processing to the video tape recorder 7 based on the timer recording input information.

Then the control section 22 of the video tape recorder 7 is able to preset the timer recording of a user requested TV program by executing the timer recording processing based on a timer recording input information in accordance with an execution command.

The control section 22 of the video tape recorder 7 recognizes the processing status of the timer recording processing and recording processing, and generates the processing status reporting mail at a time when the timer recording processing ends, when the recording processing starts, and when the recording processing ends, then transmits thus generated processing status reporting mail to the mobile phone 2, thereby the control section 22 is able to have the user confirm if the timer recording processing for the user requested TV program is carried out or not by watching the contents of “The timer recording registered TV program” displayed at the text display area 70B of the timer recording processing result reporting display image 70 in FIG. 8 in the display section 11 of the mobile phone 2, and also is able to have the user confirm if the user requested TV program is recorded or not by watching the contents of “The recording TV program” and “The recorded TV program” displayed at the text display area 80B of the recording processing start reporting display image 80 in FIG. 9 and the text display area 90B of the recording processing end reporting display image 90 in FIG. 10.

According to the above described configuration, in the timer recording system 1, when the processing contents for the timer recording processing so as to execute the timer recording for the user requested TV program are preset to the timer recording management server 6 via the mobile phone 21, then the timer recording management server 6 commands to the video tape recorder 7 to execute the timer recording processing based on such processing contents, the video tape recorder 7 executes the timer recording processing based on the processing contents preset by the mobile phone 2 in accordance with the command, and in addition the video tape recorder 7 recognizes the processing result of the timer recording processing when the timer recording processing ends, and reports the recognized result to the mobile phone 2. Accordingly, the user is able to preset the timer recording for the requested TV program to the video tape recorder 7 that the user is not able to directly operate, and is able to recognize that the timer recording is preset, and thereby the user is able to definitely operate the video tape recorder 7, even in an environment where the user is not able to directly operate.

4. Other Embodiment:

In the above embodiment, it is described in the case where the timer recording for the TV program is preset by designating the G-code, but the present invention is not limited to this, and the timer recording for the TV program may be preset by directly entering the timer recording input information such as the on-air date, the on-air channel, the on-air time, and the like.

Further in the above embodiment, it is described in the case where the video tape recorder 7 reports the processing condition of the timer recording processing and the recording processing, but the present invention is not limited to this, and the video tape recorder 7 may report other various processing such as reproducing processing and the like.

Further in the above embodiment, it is described in the case where the video tape recorder 7 reports the processing condition of the timer recording processing and the recording processing only to the mobile phone 2, but the present invention is not limited to this, and the video tape recorder 7 may report the processing condition of the timer recording processing and the recording processing to other various information processing terminal such as a mobile phone other than the mobile phone 2, a personal computer, or the like, and further may report them simultaneously to plural information processing terminals including the mobile phone 2.

Further in the above embodiment, it is described in the case where the video tape recorder 7 reports the processing condition of the timer recording processing and the recording processing directly to the mobile phone 2, but the present invention is not limited to this, and the video tape recorder 7 may report the processing condition of the timer recording processing and the recording processing to the mobile phone 2 via the timer recording management server 6. In this case, if the contents of the processing status for the timer recording processing and the recording processing are successively stored in the timer recording management server 6 as web pages, the user of the mobile phone 2 is able to confirm the processing status of the timer recording processing and the recording processing by requesting such web pages to the timer recording management server 6.

Further in the above embodiment, it is described in the case where the video tape recorder 7 reports the processing condition of the timer recording processing and the recording processing by transmitting an e-mail to the mobile phone 2, but the present invention is not limited to this, and various other method may be used. For example, an application program or the like for receiving such report is previously installed in the mobile phone 2, and the processing status of the timer recording processing and the recording processing may be reported from the video tape recorder 7 by transmitting a processing status reporting signal, which is. compatible with the application program for receiving a report, to the mobile phone 2.

Further in the above described embodiment, it is described in the case where the video tape recorder 7 reports the processing condition of the timer recording processing and the recording processing to the mobile phone 2 at the time when the timer recording processing ends, when the recording processing starts, and when the recording processing ends to the mobile phone 2, but the present invention is not limited to this, and when the video tape recorder 7 is requested the reporting of the processing status by the mobile phone 2, the video tape recorder 7 may report to the mobile phone 2 as a requester by recognizing the processing status of the timer recording processing and the recording processing. Thereby the user is able to confirm the timer recording status and recording status of the video tape recorder 7 at anytime.

Further in the above embodiment, it is described in the case where the video tape recorder 7 communicates with the timer recording management server6 via the internet 5, but the present invention is not limited to this, and the video tape recorder 7 may directly communicate with the timer recording management server 6 via a leased line or wireless line, for example. In this case, the timer recording management server 6 is to belong to the same network as the video tape recorder 7 does, so that if a unique device name is allocated to the video tape recorder 7, in advance in the network, it becomes possible to specify the video tape recorder 7. Thereby, it is not necessary to allocate an IP address unique to the internet 5 to the video tape recorder 7.

Further in the above described embodiment, the timer recording is preset to the video tape recorder 7 via the mobile phone 2 as an operation terminal, but the invention is not limited to this, and if the communication to the timer recording management server 6 is available via a wired or wireless line, the timer recording may be preset to the video tape recorder 7 via various operation terminals such as a PDA (Personal Digital Assistants), a personal computer, or the like.

Still further, in the above described embodiment, the timer recording processing is executed by the video tape recorder 7 as an electronic apparatus and a data recording apparatus, but the present invention is not limited to this, and various processing may be executed by various devices such as having an air-conditioner execute the processing for a room temperature control, having a radio-cassette recorder execute the processing for a music recording processing, or the like.

Further in the above mentioned embodiment, it is described in the case where the processing status reporting program and the timer recording command program are previously installed, however, the present invention is not limited to this, but the processing status reporting program and the timer recording command program are able to be installed by reproducing a program storage media as a package media such as a CD-ROM (Compact Disc Read Only Memory), a DVD-ROM (Digital Versatile Disc Read Only Memory), or the like which stores the processing status reporting program and the timer recording command program, or the processing status reporting program and the timer recording command program may be installed by reproducing a program storage media such as a semiconductor memory, a magneto-optical disk, or the like which stores application program temporally, or permanently.

As means for storing the processing status reporting program and the timer recording command program into the program storing medium, wired or wireless communication media such as a local area network, a digital broadcast satellite, or the like may be utilized, and further they may be stored by way of various communication interface such as a router, a modem, or the like.

What is claimed is:

1. A remote operation system including: an operation terminal; a remote operation management apparatus; and an electronic apparatus, wherein
said operation terminal presets processing contents to be executed by the electronic apparatus to said remote operation management apparatus,
said remote operation management apparatus commands to the electronic apparatus to execute processing based on the processing contents preset by the operation terminal, and
said electronic apparatus executes the processing based on the processing contents in response to the command from the remote operation management apparatus command, recognizes processing status of the processing, and reports the recognized result to the operation terminal.

2. The remote operation system as cited in claim 1, wherein
when said electronic apparatus is requested to report again the processing status of the processing from said operation terminal, the electronic apparatus again recognizes the processing status of the processing in response to the request, and again reports the recognizing result to the operating terminal which is the requester.

3. An electronic apparatus comprising:
processing executing means for executing a predetermined processing by a remote operation management apparatus based on processing contents preset by an operation terminal;
processing status recognizing means for recognizing processing status for the predetermined processing executed by the processing executing means; and
processing status reporting means for reporting recognized result by the processing status recognizing means to said operation terminal.

4. The electronic apparatus as cited in claim 3, wherein
said processing status recognizing means, when requested again by said operation terminal to report the processing result of the predetermined processing, is again recognizes the processing status of the predetermined processing based on the request, and
said processing status reporting means again reports the processing result of the processing status recognizing means to the operation terminal which is the requester.

5. The electronic apparatus as cited in claim 3, wherein
said processing status recognizing means recognizes processing starting status as the processing status of the predetermined processing when the predetermined processing starts by the processing executing means.

6. The electronic apparatus as cited in claim 3, wherein
said processing status recognizing means recognizes the processing status of the predetermined processing during the execution of the predetermined processing started by the processing executing means.

7. The electronic apparatus as cited in claim 3, wherein
said processing status recognizing means recognizes the processing result of the predetermined processing as the processing status for the predetermined processing when said predetermined processing started by the processing executing means ends.

8. A processing status reporting method comprising the steps of:
processing executing step for executing a predetermined processing commanded for a remote operation management apparatus to execute the predetermined processing based on the processing contents preset by an operation terminal;
processing status recognizing step for recognizing the processing status for the predetermined processing executed by the processing executing step; and
processing status reporting step for informing the recognized result by the processing status recognizing step to the operation terminal.

9. A processing status informing program for having an electronic apparatus execute the processing comprising the steps of:
processing executing step for executing a predetermined processing commanded for a remote operation management apparatus to execute the predetermined processing based on the processing contents preset by an operation terminal;
processing status recognizing step for recognizing the processing status for the predetermined processing executed by the processing executing step; and
processing status reporting step for reporting the recognized result by the processing status recognizing step to the operation terminal.

10. A processing status reporting program storage medium stored a processing status reporting program for executing the steps of:
processing executing step for executing a predetermined processing commanded for a remote operation management apparatus to execute the predetermined processing based on the processing contents preset by an operation terminal;
processing status recognizing step for recognizing the processing status for the predetermined processing executed by the processing executing step; and
processing status reporting step for reporting the recognized result by the processing status recognizing step to the operation terminal.

11. The electronic apparatus as cited in claim 3, further comprising:
timer control means for controlling various operation of the electronic apparatus based on the processing contents as timer control data, wherein
said predetermined processing includes timer presetting processing.

12. The electronic apparatus as cited in claim 11, wherein
said predetermined processing further includes an operating condition of the electronic apparatus.

13. A recording apparatus comprising:
timer control means for controlling various operation of the recording apparatus based on processing contents as timer control data;
processing executing means for executing a predetermined processing by a remote operation management apparatus based on the timer control data preset by an operation terminal;
processing status recognizing means for recognizing processing status for the predetermined processing executed by the processing executing means; and
processing status reporting means for reporting recognized result by the processing status recognizing means to said operation terminal, wherein
said predetermined processing includes timer presetting processing.
